(19) United States
(12) Patent Application Publication
(10) Pub. No.: US 2008/0205567 A1
(43) Pub. Date: Aug. 28, 2008

(54) Methods and Receives of Data Transmission Using Clock Domains

(75) Inventor: Andrei Radulescu, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/917,083

(22) PCT Filed: Jun. 12, 2006
(86) PCT No.: PCT/IB06/51856

§ 371 Date: Dec. 10, 2007

(30) Foreign Application Priority Data
Jun. 13, 2005 (EP) 05105166.2

(51) Int. Cl. H04L 7/00

(52) U.S. Cl. 375/356; 375/354

(57) ABSTRACT

A receiver (RCV) for receiving data from a transmitter, comprises a first clock domain operating at a data rate synchronous with a clock of the transmitter, and having an input (RI) for receiving data. The data includes primary data, secondary data and control data. The receiver further has a second clock domain operating at a clock rate independent from the transmitter, and a clock-domain crossing unit for transferring data from the first to the second clock domain. The receiver further includes a slot counter for counting a number of units of received data converted by the clock-domain crossing unit into the second clock domain, a first identification unit (PRIM) for identifying control data indicative for the presence of primary and secondary data and a second identification unit (PAUSE) for identifying control data indicative whether slot counter of the receiver will be updated or not. It has an output (RO) for communicating an indicator indicative for the value of the slot counter. The receiver cooperates with a transmitter comprising a unit (M1, HEAD, TRAIL, PAUSE, PRIMARY, SECONDARY) for transmitting primary data and control data, a counter (slot) for counting the transmitted amount of data of the primary type, an input (TI) for obtaining an indication for a received amount of primary data. The transmitter further comprises a facility (S2) for calculating the difference between the transmitted amount of primary data and the received amount of primary data, the unit for transmitting data being controlled by the outcome (ns) of this calculation.

The present invention relates to a transmitter.

The present invention further relates to a method of transmitting.

The present invention further relates to a receiver.

The present invention further relates to a method of receiving.

The present invention further relates to a data handing unit.

The present invention further relates to a network.

The present invention further relates to a mobile device.

The interconnect centric approach offers a powerful way to rapidly develop new systems. In such an approach the system is developed as a plurality of nodes. The nodes, also denoted as data handling units, comprise functional units e.g. storage units, dedicated processors, general processors and data routing units such as routers and switches. The functional units are arranged in a network formed by the data routing units. It is noted that such a network may be a network on chip, a network coupling various integrating circuits, or a network coupling various computers. It is a fact that the communication protocol of the nodes tends to be standardized, and that a network like architecture may easily be expanded with new nodes, facilitating design. For cost and power reasons, links between the nodes are serial, use differential low-swing signaling, and run at high frequencies (1 GHz and above). At these speeds it is not possible to run a multiple chip system at a single clock. For this reason each chip has a local clock. Despite the fact that the clocks can mutually have the same nominal frequency, variations within known tolerance will in practice occur. These variations are caused by imperfections in the crystal oscillators and local temperature differences. In other systems various nodes may have intentionally different clockrates. Data transfer is still synchronous to a clock driven by the data producing node (transmitter). The clock is either sent on second serial pair of wires (source synchronous data transmission), or the clock is embedded in the data wires using for example an 8b10b encoding as in PCI Express. The data is sampled in the destination node (receiver) using the clock of the transmitter sent together with the data. Using one of the known clock-domain crossing techniques, data is then transferred to the clock domain of the receiver. When implementing systems providing guaranteed performance, one must control precisely the usage of the resources in the system. One cost-effective way of achieving this is to define frames of slots in which slots are reserved for guaranteed-throughput communication. This data for which a guaranteed throughput is required will also be denoted as primary data in the sequel. Data used for control of various functions will be denoted as control data. Such a system requires that frames in all devices and switches are synchronized.

It is a purpose of the invention to synchronize the transmission of the frames between the nodes, despite the fact that the nodes have independent clocks.

According to the invention this purpose is achieved with a receiver as claimed in claim 1.

According to the invention this purpose is achieved with a method for receiving as claimed in claim 6.

According to the invention this purpose is achieved with a transmitter according to claim 7.

According to the invention this purpose is achieved with a method of transmitting according to claim 8.

In a practical embodiment a receiver according to claim 1 and a transmitter according to claim 7 are combined in a data handling unit as claimed in claim 12. A plurality of data handling units may be combined in a network as claimed in claim 13.

According to the invention on the one hand the receiver communicates to the transmitter the number of slots with primary data that it has received, and converted to its own clock domain. The transmitter uses this information to determine whether the receiver is lagging or leading. If it determines that the receiver is lagging it interrupts its transmission of primary data and signals this to the receiver by transmission of a pause symbol, which is a particular form of control data. In this way the transmitter and the receiver are mutually synchronized.

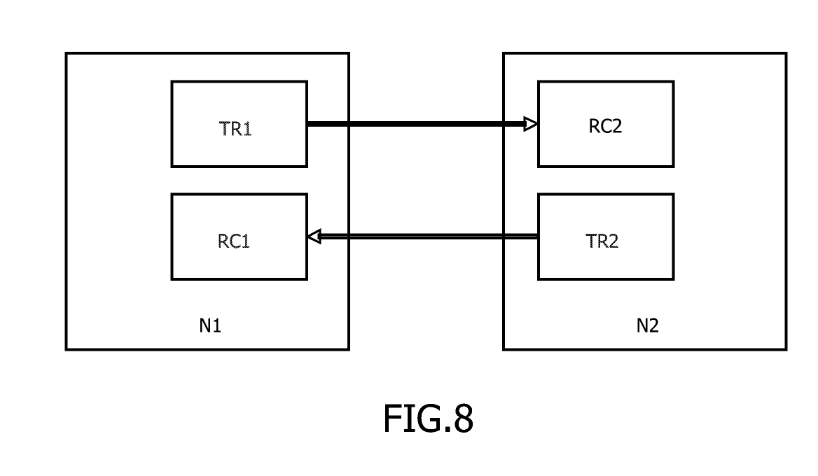

In practice, a node will comprise both a receiver and a transmitter as is schematically shown in FIG. 8. They share a counter: ‘ns’. The transmitter sends data to all its neighbours to signal it slows down. The receivers are those part of a node that run being driven by the clocks in the neighbours. Using a standard clock domain crossing (e.g., 2 flip-flops, or a fifo), the received data is transferred in the node's clock domain which comprises the transmitter. As a result, the transmitter doesn't signal PAUSEs to the receivers, but sends PAUSE messages to its neighbours. The goal is to synchronize the node and the neighbours. In a network of data handling units the mutual synchronization of each pair of nodes results in a global synchronization of network allowing for a global scheduling of primary data traffic.

These and other aspects of the invention are described in more detail with reference to the drawings. Therein

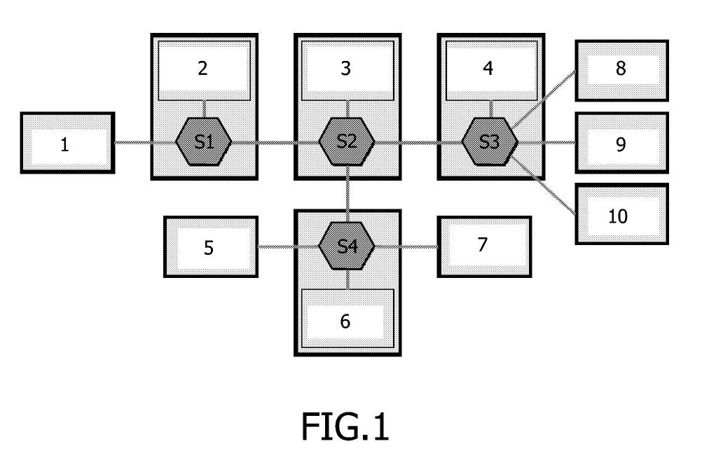

FIG. 1 schematically shows a data processing system in which the present invention may be applied,

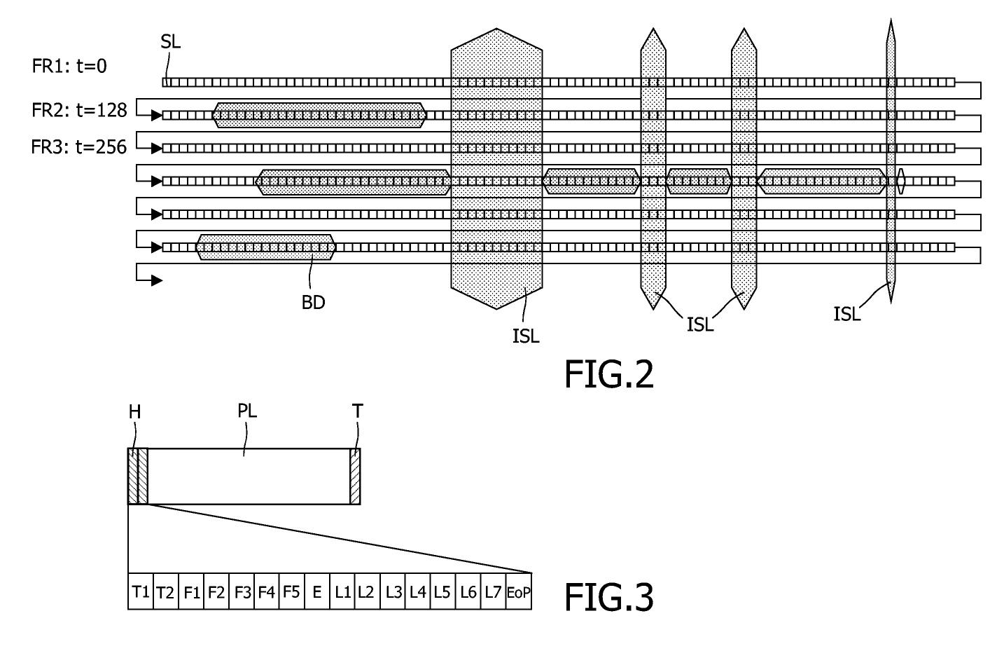

FIG. 2 schematically illustrates a scheme of data transfer between two nodes.

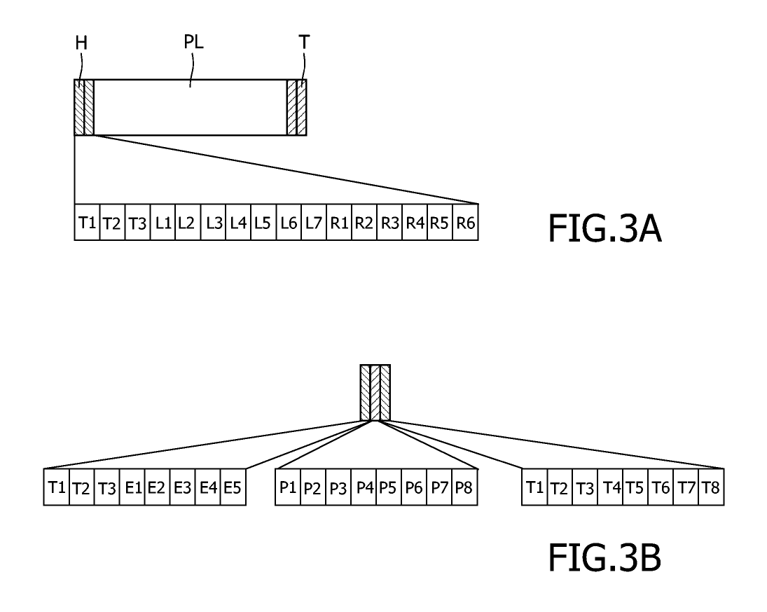

FIG. 3 shows an example of a data packet in more detail.

FIG. 3A shows an example of a data packet in another embodiment of the invention,

FIG. 3B shows an example of an escape symbol in said another embodiment,

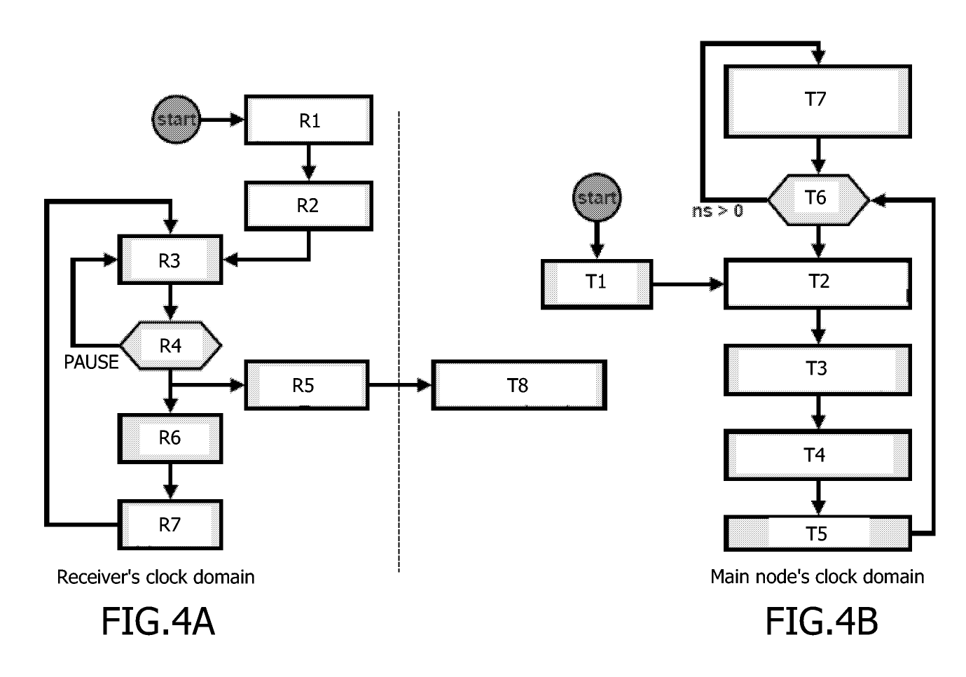

FIG. 4A schematically shows a method for receiving data, and

FIG. 4B schematically shows a method for transmitting data,

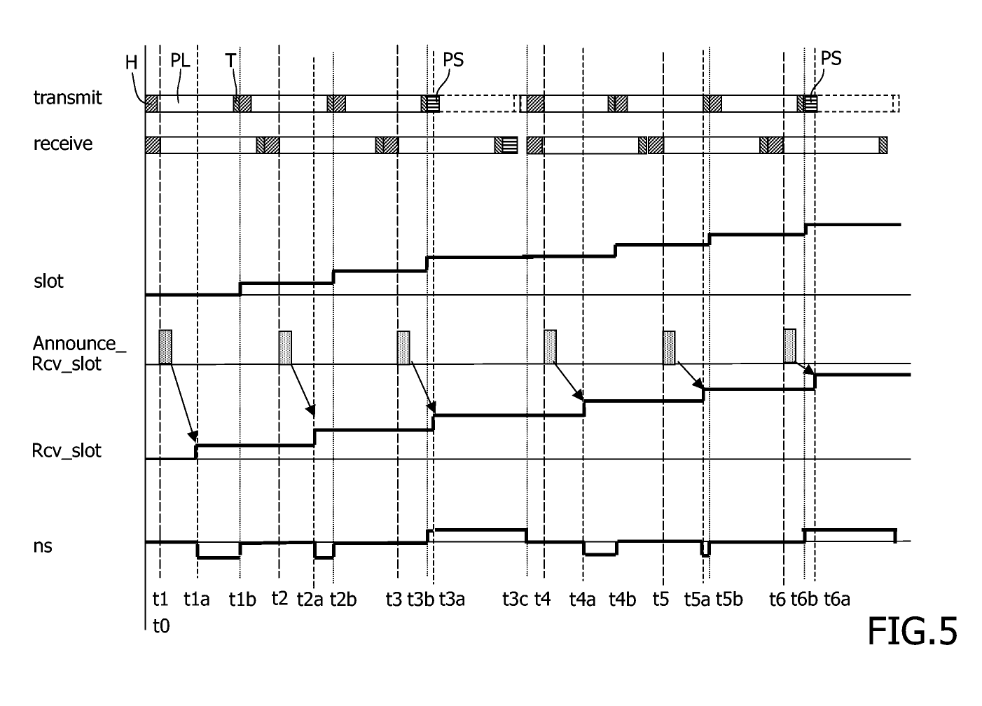

FIG. 5 schematically shows the interaction between a transmitter and a receiver as a function of time,

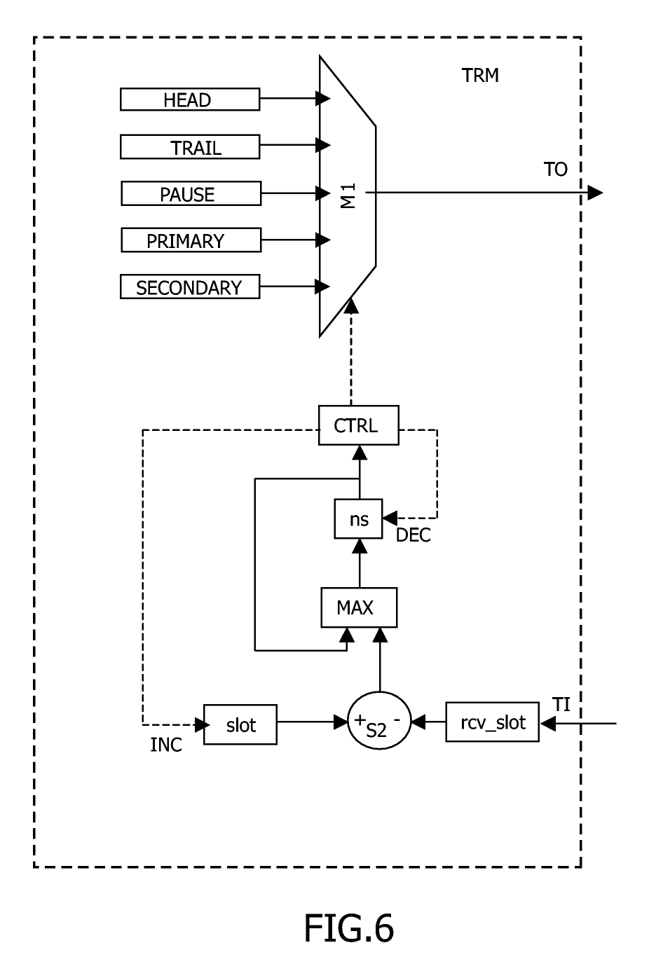

FIG. 6 schematically shows an embodiment of a transmitter according to the invention,

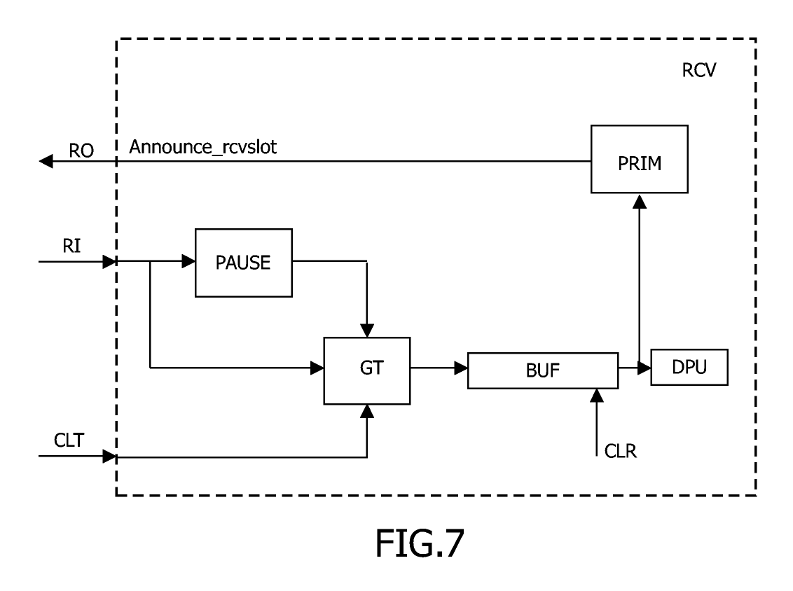

FIG. 7 schematically shows an embodiment of a receiver according to the invention.

FIG. 8 schematically shows a pair of nodes both comprising a combination of a transmitter and a receiver according to the invention.

FIG. 1 schematically shows a data processing system in which the present invention may be applied. The data processing system shown is a camera having various functional units, such as a modem 1, a communication accelerator 2, a first and a second general purpose processing engine 3, 6, a media accelerator 4, a camera 8, a display 9 and a mass storage units 5 and 10 as well as an auxiliary device 7. The functional units are coupled in a network by switches S1, S2, S3 and S4. The various functional units and switches each operate at their own clock. Although the clocks may approximately have the same speed, an exact synchronization of the clocks cannot be provided. When transmitting guaranteed data, such as isochronous data it is essential that the transmission is globally synchronized in the network. The present invention provides a communication scheme that guarantees that this condition is fulfilled.

FIG. 2 schematically illustrates a scheme of data transfer between two nodes. In the scheme shown, the available time for data transmission is subdivided in time-slots (SL), which are indicated as rectangles. Each time-slot is available for transfer of a packet of data. Part of the time slots is reserved for data requiring a guaranteed throughput, here denoted as primary data such as isochronous data. In this example these time slots are indicated by areas ISL. The other time slots are not reserved in advance, but can be granted at run-time for use by other data, also denoted as secondary data. Arbitration mechanisms known as such, e.g. round robin, priority scheduling may be used to select a data packet if two or more data sources want to transfer data along the same link. The remaining data can be transferred as bulk data BD, or as separate chunks of data. As can be seen in FIG. 2, the slot reservations repeat after a fixed number of slots. This fixed number of slots is denoted here as a frame. In this case a frame comprises 128 slots, but any number could be applied. Here a first frame FRI starts at t=0, a second frame starts at t=128, where the time unit is the duration of a slot.

In a practical embodiment a packet comprises for example 131 bytes and slot has a duration of approximately 1 μs. This corresponds to a data transmission rate of 1 Gbps. In this example, where a frame comprises 128 slots, the frame repetition rate is 8 kHz.

FIG. 3 shows an example of a data packet in more detail. The data packet shown comprises a header H, a payload PL and a trailer T. In the embodiment shown the header H, payload PL and trailer T respectively comprise 2, 128 and 1 byte. As shown in more detail in the lower part of FIG. 3, header H comprises the following information about the remainder of the packet:

A type indicator T1, T2. These two bits encode the following types:

Empty: An empty type of packet indicates that the link is active, but that the transmitted packet contains no data.

Isochronous, indicates a prescheduled package of a stream requiring a guaranteed throughput. This type of data is indicated as primary data.

Best_effort, or secondary data, the transmission of which is scheduled at run-time.

Escape: The escape type allows for a different format of the remainder of the header, which can be useful for various control functions, e.g. for activate a link via which the data is communicated, to deactivate the link, or to indicate an error.

The flow control bits F1, . . . , F5 serve to indicate to the receiver of the packet a number of credits. This number indicates the number of packets that can be accepted until buffer overflow occurs.

In case of an irrecoverable error a packet may be returned with the error flag E set. In response the device receiving the returned packet will execute a retransmission.

The number of bytes used in a packet is indicated by the bits L1, . . . , L7.

The last packet in a sequence of BE packets is indicated by the EoP flag.

The trailer of the packet is preferably used for an error correction/detection code.

An alternative data format is shown in FIG. 3A. In this format a greater number of different types of packets is provided for so that for example flow-control and error information is sent as separate messages, instead of sending them together with a payload.

The greater number of types is encoded with type bits T1, T2, T3. Various types are for example

ISOC isochronous data

BE control data, e.g. data for controlling a setting of the device, e.g. volume control, contrast control, which usually only comprises a single packet.

BE bulk. Best effort data that comprises a plurality of packets.

ESC symbols. The latter may be of normal or urgent type.

The header may in addition comprise further data for indicating a source and a destination in the data. For isochronous this information may be encoded in the slot table.

FIG. 3B shows in more detail the format of an escape symbol. Whereas the type bits T1, T2, T3 indicate that an escape symbol is present, the bits E1, . . . , E5 identify the nature of the escape symbol: Escape symbols may be of type normal or urgent:

An example of a normal escape symbol is ESC_FC, which is used for flow control. In this case the payload P1, . . . , P8, indicates the receiver the number of credits, i.e. the number of data units, which the transmitter of the escape symbol is ready to accept.

Escape symbols of type panic should be handled with urgency. These are for example

ESC_ERROR: to indicate that a received package has an irrecoverable error, and should be retransmitted.

In case of the ESC_SYNC, the payload comprises a slot number.

ESC_PAUSE is used to indicate that the transmitter temporarily stops transmitting primary data to allow the receiver to remain in pace with the transmitter.

As in the case of other data the ESC symbol includes a trailer for error checking and correction.

When handling packets, preferably the following priorities should be given:

1 (highest priority). Panic ESC symbols, such as ERROR, SYNC and PAUSE.
2. Isochronous datatraffic, and
3. Normal ESC symbols: FLOW_CTRL
4. BE control
5. (lowest priority) BE bulk

FIG. 4A schematically shows a method for receiving data, and FIG. 4B schematically shows a method for transmitting data. The steps carried out by the transmitter are indicated by T1, . . . , T8. The steps carried out by the receiver are indicated by R1, . . . , R7

In step T1 of the transmitter after startup, a slot counter slot and a difference indicator ns are both initialized at 0.

In step T2 it is determined for which connected nodes data is available. Subsequently the links connecting those nodes are activated.

In step T3 those links connecting to nodes for which no data is available, are set into a sleep-mode.

Alternatively, in environments having no power constraints, e.g. apparatus supplied by the mains, all links may be kept active continuously.

In step T4 the available data is transmitted in the form of a packet to its destination. In this embodiment the packet comprises primary data as a payload, and control data in the form of a header and/or a trailer. The control data in the header indicates whether it is followed by primary data in the form of a payload. In addition the control data may indicate the length of the payload.

In step T5 the slot counter is incremented, which is representative for the transmitted number of units of primary data. The step of incrementing the counter may be executed before the step of transmitting the primary data.

In step T6, it is verified whether the value of the difference indicator ns is greater than 0. The value of ns is the number of transmitted primary data units slot minus the number of primary data units which are received rcv_slot.

In step T7 a PAUSE symbol is transmitted. Subsequently the difference indicator ns is decreased by 1. The PAUSE symbol forms control data indicating to the receiving node (receiver) that there is no primary data. In this embodiment the PAUSE symbol replaces one packet of primary data. In other embodiments a different granularity may be selected, e.g. a PAUSE symbol replacing a single byte of primary data, or a PAUSE symbol replacing number of packets.

The operation of the receiver is now illustrated with reference to FIG. 4A. In step R1 the receiver enters active power mode. Active power mode may be initiated by a special control word from the transmitter, or by power on of the data-processing system. In step R2 it receives a control word indicative for a slot number of the next unit of primary data that will be transmitted by the transmitter. It initializes a slot counter with this data. In step R3 the receiver receives a next unit of control data. In step R4 the receiver determines whether this control data unit indicates whether it is followed by primary data or whether it is a PAUSE symbol. In the latter case the receiver waits for the next data unit in step R3. In the case that the unit of control data indicates that it is followed by a payload of primary data, the receiver confirms receipt in step R5, increments its slot counter in step R6, and receives the primary data in the form of a payload and eventually further control data in the form of a trailer. The steps of confirming, incrementing and receiving may be executed in any order or executed in parallel. After steps R5, R6 and R7 the receiver continues with step R3.

The slot counter rcv_slot will also be incremented upon receipt of a packet of type EMPTY, or a packet containing secondary (best-effort) data. However, a bonus packet of secondary data, for which the rcv_slot is not incremented, may be transmitted immediately following the PAUSE symbol.

Alternatively a separate escape symbol may be used, e.g. indicated as ESC_STOP_SLOT for example, which, when preceeding an EMPTY or BE-packet suppresses an incrementation of the rcv_slot counter.

Upon receipt of the confirmation in step T8 the transmitter calculates the difference d between the number of transmitted slots of primary data slot and the number of received slots rcv_slot of primary data.

d=slot−rcv_slot

The counters slot and rcv_slot are wrap around counters, which can have a relatively low maximum value, in a practical embodiment for example 128. Due to the tight frame synchronization, the difference between the counters is limited to a small value, e.g. 1 or 2, so that aliasing is avoided.

In an alternative embodiment, does not store a counter for the number of received slots rcv_slot, but stores and updates this difference directly. In the alternative embodiment, when the link is activated, a word is received with the slot position of the neighbour (rcv_slot).

As a result, ‘d’ is initialized with (slot-rcv_slot). Following this, ‘d’ is incremented when the node's slot is incremented, and decremented when a data for a slot has been received from the neighbour.

In case of only a single receiver, the difference indicator ns is equal to this difference.

However, in case of a plurality of receivers, the transmitter has to adapt to the slowest one. In that case the difference indicator is calculated as:

ns=max(ns, d)

FIG. 5 schematically shows the interaction between a transmitter and a receiver as a function of time. In this example it is assumed that the receiver has a slower clock than the transmitter. For the purpose of illustrating the present invention this difference in clock speed is strongly exaggerated in the Figure. In practice the difference in clock speed is for example in the order of 0.1%.

At t0 the transmitter sends a first packet comprising a header, a payload and a trailer. The payload comprises of primary data and the header and trailer comprise control data At t1 the receiver has recognized the header and sends a message announce rcv_slot. After this message is received by the transmitter of the packet of data the counter rcv_slot is incremented at t1a. Immediately the difference indicator ns is recalculated, and obtains the value minus one. At t1b the transmitter has completed transmission of the packet and increases the slotcounter slot. In addition the difference-indicator ns is recalculated and obtains the value 0 again. Now the transmitter verifies the value of ns in step T6 and decides that a new packet can be transmitted. The receiving module recognizes the header at t2 and sends a message announce rcv_slot. Upon receipt of this message at t2a, the transmitting module increments the counter rcv_slot and recalculates the value of ns, which obtains the value −1. At t2b the transmitter has completed transmission of the packet, increments counter slot, and recalculates the value of ns, which becomes 0 again. As this value is again 0, when the transmitter executes step T6, it decides to send a next packet. At t3 the receiver has received and processed the header of this packet and transmits a message announce_rcv slot. At t3a the transmitter has received this message, and increments the counter rcv_slot. However, due to the higher clock speed of the transmitter, the latter has already finished transmitting its packet before this point in time, at t3b, and has increased its slot counter before t3a. Consequently, at the moment that the transmitter executes step T6 it finds that the difference indicator is greater than 0. Consequently, instead of transmitting a packet, it now transmits a Pause symbol PS. After transmission of the Pause symbol it refrains from sending a payload and a trailer, so that the receiver has time to process the previous packet. At t3c, after the time slot is completed following the Pause symbol, the transmitter decrements the difference indicator ns with 1 to 0, and subsequently it transmits a next packet. During the period after the Pause symbol, wherein the transmitter refrains from sending primary data, it may continue transmitting Pause symbols. Alternatively it may enter a low-power mode. In again another embodiment it may transmit secondary data, e.g. best effort data. In the embodiment shown here, the Pause symbol indicates that the receiver refrains from transmitting 1 packet of primary data. In another embodiment the transmitter may interrupt transmission of primary data for a period longer than one packet. In that case the duration may have a predetermined duration e.g. the duration of a fixed number of packets. Alternatively the Pause symbol may include an indication for the length of the period during which transmission of primary data is interrupted.

When the receiver has received the Pause symbol it is ‘aware’ that the transmitter refrains from transmitting the primary data. Consequently it refrains from communicating an ‘announce-receive slot’

Due to the interrupted primary data stream, the receiver can now immediately start to process the next data packet transmitted by the transmitter at t3c, and send an ‘announce-receive slot at t4. From that point in time the procedure repeats. At t6b the delay of the receiver is again incremented to such an amount that the difference indicator is greater than 0, and the transmitter again transmits a Pause symbol.

FIG. 6 schematically shows an embodiment of a transmitter TRM according to the invention. A controller CTRL controls a multiplexer M1 that selects one of a plurality of data sources to provide data for the output. In this case a data source HEAD is comprised, which provides a header for a data packet. In practice various headers may be used depending on the type of data, e.g. best effort data, or isochronous data, it may comprise information about the length of the payload. A second data source TRAIL provides a trailer, which may comprise for example an error correction code. A third data source provides a PAUSE symbol to indicate that the transmitter interrupts transmission of primary data. A fourth data source PRIMARY provides the primary data. A fifth data source SECONDARY provides secondary data. Various other data sources may be present for selection, e.g. to provide various control symbols, e.g. for activate a link via which the data is communicated, to deactivate the link, or to indicate an error.

The transmitter has an output TO for providing the selected data to a receiver. The transmitter further has an input TI for receiving the announced number of received slots.

In the process of transmitting primary data the controller observes the value of difference indicator ns. The difference indicator is decremented with signal DEC when a PAUSE symbol is transmitted and when the number of transmitted slots slot or the number of received slots, announced by the receiver, is updated. To that end the difference indicator is coupled to a subtractor S2 via a maximum function module MAX. The latter module has apart from a first input coupled to the subtractor S2 a second input coupled to difference indicator register. The subtractor calculates a difference between the actual number of transmitted primary data units (slot), and the number of primary data units rcv_slot that the receiver has announced it has received. This embodiment has the advantage that the transmitter can adapt to the receiver with the slowest clock.

FIG. 7 schematically shows an embodiment of a receiver according to the invention. The receiver RCV has an input RI for receiving a stream of data from the transmitter TRM at a data rate corresponding to the clock of the transmitter. It further has a first comparator PRIM for determining whether the data it is receiving is the header of a packet of primary data. In that case it transmits a message announce_rcvslot to the transmitter. The receiver further has a second comparator PAUSE, for recognizing whether it has received a PAUSE symbol. This comparator control a gate GT which couples a buffer BUF to the input I. If a PAUSE symbol is recognized, the gate is closed so that filling of the buffer is interrupted during a length of time corresponding to a data packet. Otherwise the gate GT is opened, so that the buffer can be filled at the speed of the clock CLT of the transmitter. In the embodiment shown, the clock CLT is provided via a separate connection. In another embodiment the clock is embedded in the data stream. The buffer is read out by a data processing unit DPU at a clock rate CLR of the receiver. Instead of interrupting the filling of the buffer when a PAUSE symbol is recognized, all data may be loaded in the buffer. In that case a read pointer indicative for the current position that is read from the buffer may be advanced with a number of positions corresponding to the size of a packet. Alternatively the PAUSE symbol may include information indicating the number of positions in the buffer that may be skipped.

FIG. 8 schematically shows a pair of nodes. The first node N1 comprises a combination of a transmitter TRI and a receiver RC1. The second node N2 comprises a combination of a transmitter TR2 and a receiver RC2.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. In the device claim in numerating several means, several of these means can be embodied by one and the same item of hardware. The mere fact that certain measures are resided in mutually different dependent claims does not indicate that a combination of these measures cannot be used to advantage.

The following document is included as an integral part of this application: 2005-06-14-ups-unipro-paris.ppt Furthermore, any reference signs in the claims shall not be constitute as limiting the scope of the claims.

1. Receiver (RCV) for receiving data from a transmitter, comprising
a first clock domain operating at a data rate synchronous with a clock of the transmitter, and having an input (RI) for receiving data the data including primary data, secondary data and control data,
a second clock domain operating at a clock rate independent from the transmitter,
a clock-domain crossing unit for transferring data from the first to the second clock domain,
a slot counter for counting a number of units of received data converted by the clock-domain crossing unit into the second clock domain,
a first identification unit (PRIM) for identifying control data indicative for the presence of primary and secondary data,
a second identification unit (PAUSE) for identifying control data indicative whether slot counter of the receiver will be updated or not,
an output (RO) for communicating an indicator indicative for the value of the slot counter.

2. Receiver according to claim 1, wherein the clock-domain crossing unit comprises a buffer, and the second identification unit (PAUSE) prevents data from entering the buffer if it detects an absence of primary data

3. Receiver according to claim 1, wherein the second identification unit (PAUSE) prevents the slot information in the receiver to be updated.

4. Receiver according to claim 1, wherein the clock-domain crossing unit comprises a buffer, all data being entered in the buffer, a data processing unit (DPU) selecting primary data from the buffer.

5. Receiver according to claim 1, wherein the receiver has a counter being initialized with a value transported by an escape symbol ESC_SYNC.

6. Receiver according to claim 5, wherein the escape symbol ESC_SYNC for counter initialization is transferred at the link activation.

7. Receiver according to claim 1, wherein the receiver has a counter for counting a number of received primary and secondary data units and communicates the counted number to the transmitter.

8. Receiver according to claim 1, wherein the receiver communicates the occurrence of receiving a primary or secondary data unit (rcv_slot).

9. Method for receiving data from a transmitter comprising the following steps,
A. receiving a data word (R3),
B. identifying the data word (R4),
C. if the data word is a control word indicative for the absence of primary data continue with step A
D. otherwise receiving a packet of words (R7) at a clock determined by the neighbour's transmitter,
F. communicating an indicator for receipt of the packet to the transmitter (R5) when at least a part of the packet has been read,
G. continue with step A.

10. Transmitter (TRM) comprising
a unit (M1, HEAD, TRAIL, PAUSE, PRIMARY, SECONDARY) for transmitting primary data and control data,
a counter (slot) for counting the transmitted amount of data of the primary type,
an input (TI) for obtaining an indication for a received amount of primary data,
a facility (S2) for calculating the difference between the transmitted amount of primary data and the received amount of primary data,
the unit for transmitting data being controlled by the outcome (ns) of this calculation,

11. Method of transmitting primary data from a transmitter to a receiver in a network, comprising the steps of
transmitting units of primary data (T4),
counting the transmitted number of units of primary data (T5),
receiving an indication for the number of units of primary data received by the receiving node (T8),
determining a difference between the transmitted number and the received number (T8),
if the received number of primary data units is less than the transmitted number of primary data units, transmitting control data indicative that primary data is absent (T7).

12. Method according to claim 9, wherein the transmitter continues transmitting said control data until the difference between the transmitted number (slot) and the received number (rcv_slot) is reduced to zero.

13. Method according to claim 9, wherein the transmitter temporarily stops transmission after transmission of the control data indicative for the absence of primary data.

14. Method according to claim 9, wherein the transmitter transmits a unit of secondary data after transmission of the control data indicative for the absence of primary data.

15. Data handling unit comprising a combination of a receiver according to claim 1 and a transmitter (TRM) comprising
a unit (M1, HEAD, TRAIL, PAUSE, PRIMARY, SECONDARY) for transmitting primary data and control data,
a counter (slot) for counting the transmitted amount of data of the primary type,
an input (TI) for obtaining an indication for a received amount of
a facility (S2) for calculating the difference between the transmitted amount of primary data and the received amount of primary data,
the unit for transmitting data being controlled by the outcome (ns) of this calculation.

16. Network comprising a plurality of data handling units as claimed in claim 15.

17. Mobile electronic device containing a network as claimed in claim 16.
